(19) United States
(12) Patent Application Publication
(10) Pub. No.: US 2024/0127773 A1
(43) Pub. Date: Apr. 18, 2024

(54) Cymbal mounting and retaining device

(71) Applicants: Darrell Baker, San Jose, CA (US); Kelvin Limm, EI Dorado Hills, CA (US)

(72) Inventors: Darrell Baker, San Jose, CA (US); Kelvin Limm, EI Dorado Hills, CA (US)

(21) Appl. No.: 18/453,911

(22) Filed: Aug. 22, 2023

Related U.S. Application Data
(60) Provisional application No. 63/474,675, filed on Sep. 6, 2022.

(51) Int. Cl. G10D 13/10; G10D 13/063

(52) U.S. Cl. CPC G10D 13/28; G10D 13/063

(57) ABSTRACT

The Invention pertains to a hardware device designed for mounting, securing, and retaining cymbals on cymbal stands, boom arms and cymbal holders. The device addresses drawbacks of existing cymbal mounting systems by offering unique features that enhance use across a wide range of cymbal stands and cymbal holders by assisting with mounting and removing cymbals, transporting and storing cymbal stands and equipment, and optimizing sound quality of cymbals during use. Key design features enable users to mount cymbals with one hand without having to remove and reinstall a retaining component, and prevent loss of cymbal felts and sleeves when cymbals are removed from cymbal stands or equipment. The length of the device allows secure attachment to cymbal stands and holders with varying cymbal tilter rod lengths. The device eliminates the need for additional mounting components, streamlines the setup process, reduces time-consuming assembly and disassembly, and prevents loss of ancillary components.

### FIELD OF THE DISCLOSURE

Field of the Disclosure: The present invention relates to apparatus for mounting a musical cymbal onto a conventional cymbal stand.

### BACKGROUND

Conventionally, a cymbal is placed on a threaded rod at the top of a cymbal stand or cymbal arm, referred to as a cymbal tilter rod. A sleeve is typically placed on the rod onto which the cymbal is placed sandwiched between upper and lower cylindrical felt washers on the sleeve, and a butterfly nut or similar retaining component is screwed onto the threads of the rod to secure the sleeve, felt washers and cymbal onto the cymbal stand or arm. This problematic method of mounting a cymbal suppresses natural movement and vibration of the cymbal, and thereby stifles the cymbal's natural sound. Further, the action of the cymbal when played causes the retaining nut to become unscrewed, and the cymbal and all components come off the rod. Losing the cymbal mounting components when assembling, disassembling, and transporting stands and arms before and after performances is also a known issue in the industry.

### SUMMARY OF THE INVENTION

The cymbal mounting and retaining device is designed to replace the conventional upper felt washer and butterfly nut components described above. Its design specifically eliminates the upper felt washer and retaining nut as well as ensures the cymbal mounting and retaining device makes no contact with the cymbal, thus allowing complete natural movement and vibration of the cymbal during use which in turn results in the cymbal retaining its intrinsic sound. The cymbal mounting and retaining device is designed in a manner wherein no other securing components are required to prevent the cymbal from falling off when played, and prevents the loss of critical cymbal mounting components, such as the felt washer and sleeve, from falling off during transport of the cymbal stand or arm. The cymbal mounting and retaining device is designed to be permanently mounted on the rod, enabling a player to install and remove a cymbal with one hand, and simplifies assembly and disassembly of cymbal stands and arms during equipment set up and break down.

### DETAILED DESCRIPTION OF THE INVENTION

The cymbal mounting and retaining device is manufactured of a solid material such as metal, steel, aluminum, or rigid plastic. The device, depending on the material type, can be produced either by additive or subtractive manufacturing processes. The device is designed to include screw threads such that it can be mated and secured to the threaded section of the tilter rod on the top of a cymbal stand, boom arm or cymbal holder. Once installed, the device is left in place on the cymbal stand, boom arm, or cymbal holder, and its dimensions eliminate the need for additional components to secure the cymbal from the top. The top of the device is designed and dimensioned to enable a cymbal to be slid over the device with one hand, such that the cymbal rests on a felt washer sitting on the cymbal sleeve as shown in FIGS. 2 and 3. The top of the device is also dimensioned to prevent the felt and sleeve from naturally falling off the rod when no cymbal is installed and the cymbal stand or arm is inverted, such as when transporting or storing the stand or arm. The outside diameter of the cymbal mounting and retaining device shaft is smaller than the hole in the cymbal to facilitate mounting and removing the cymbal without causing damage to the cymbal. The device may include features to enable the use of a wrench to tighten the unit onto the tilter rod of a cymbal stand, boom arm or other cymbal holder. The cymbal mounting and retaining device is designed to fit over the threaded section at the top of the cymbal stand, boom arm, or cymbal holder with enough length to ensure that the cymbal mounting and retaining device can be threaded completely and robustly onto any length cymbal stand tilter rod thereby maintaining a secure fit.

### BRIEF DESCRIPTION OF THE DRAWINGS

FIG. 1: FIG. 1 illustrates a perspective view of the cymbal mounting and retaining device. This illustration is the suggested figure for publication.

FIG. 2: FIG. 2 illustrates an exploded view of components in a typical cymbal assembly with the cymbal mounting and retaining device shown at the top.

FIG. 3: FIG. 3 depicts a boom arm which is available as an option on conventional cymbal stands, as well as is available as a stand-alone cymbal holder that is typically attached to various other cymbal and drum mounting equipment.

FIG. 4: FIG. 4 illustrates a cross-sectional view of a typical cymbal assembly with the cymbal mounting and retaining device shown at the top.

FIG. 5: FIG. 5 illustrates specific features in a detailed view of the cymbal mounting and retaining device.

FIG. 6: FIG. 6 illustrates a perspective from the bottom view of the cymbal mounting and retaining device revealing the thread features of the device.

For simplicity and clarity of the illustrations, elements in the figures are not necessarily drawn to scale, and the same reference numbers in different figures denote the same elements.

### DETAILED DESCRIPTION OF THE DRAWINGS

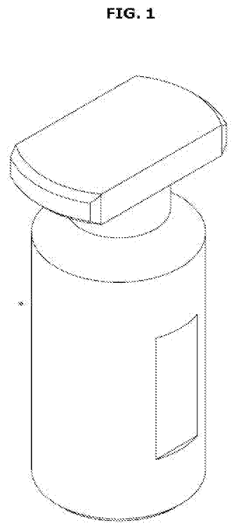

FIG. 1 illustrates the cymbal mounting and retaining device and is the suggested figure for publication.

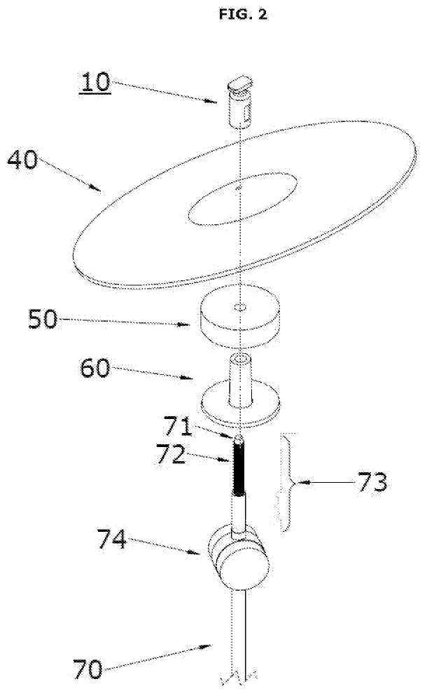

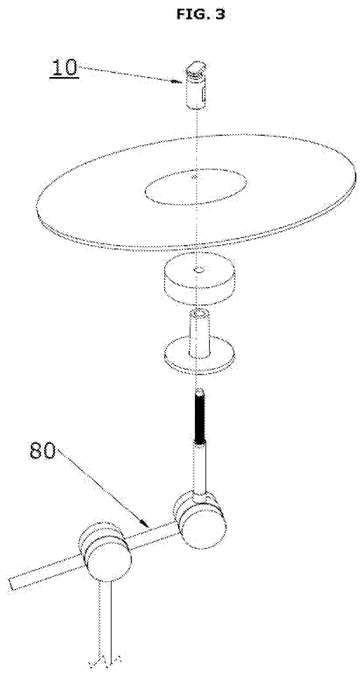

FIGS. 2 and 3 illustrate the location of the cymbal mounting and retaining device 10 in relation to other components in a typical stack up where a shouldered washer referred in industry as a cymbal sleeve 60 is placed on the tilter rod of a cymbal stand, boom arm or cymbal holder 70 and seated at the base of the threaded section 72 of a cymbal stand, boom arm or cymbal holder tilter rod 70. The cymbal sleeve 60 in turn supports a felt or rubber washer 50 onto which a cymbal 40 is placed. The cymbal mounting and retaining device 10 is attached and secured in place with use of a threaded feature to the protruding threads 72 of the tilter rod 73 of a cymbal stand, boom arm or cymbal holder 70.

FIG. 2 illustrates an exploded view of the components described above. FIG. 2 also illustrates the unthreaded portion 71 of the tilter rod of a cymbal stand, boom arm or cymbal holder 70. The unthreaded portion 71 can be of varying lengths. The cymbal mounting and retaining device 10 is designed to accommodate a wide range of industry standard unthreaded tilter rod 71 lengths. The tilter 74 is a mechanism that allows a user to rotate and orient the tilter rod 73 such that the cymbal can be presented in the desired position.

FIG. 3 represents the same components as shown in FIG. 2 with the addition of a boom arm 80 which is available as an option for conventional cymbal stands. A boom arm 80 is also available as a stand-alone cymbal holder that is typically attached to various other cymbal and drum mounting equipment. The cymbal mounting and retaining device 10 can also be utilized with such equipment.

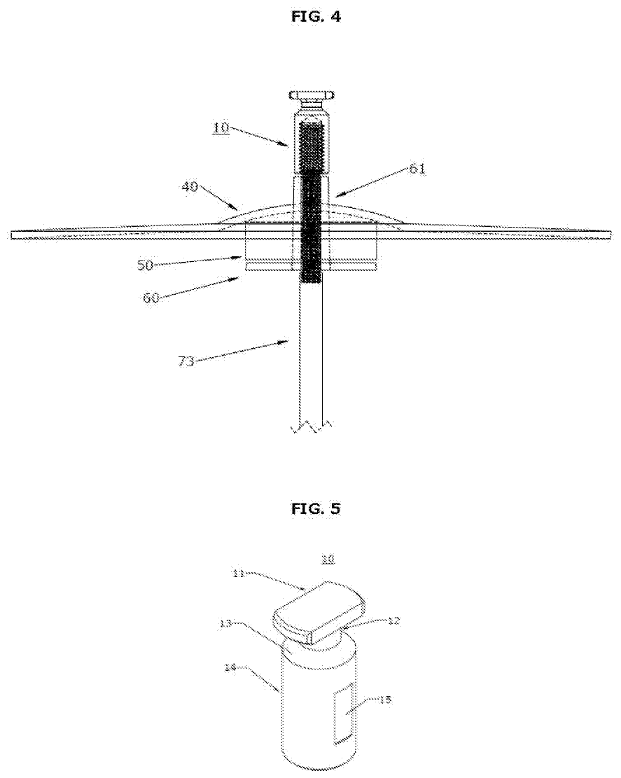

FIG. 4 is a cross-sectional view of the assembly with components stacked in place on the tilter rod 73. In this view, the cymbal sleeve 60 is shown protruding through and above 61 the cymbal 40.

FIG. 5 identifies features of the cymbal mounting and retaining device 10. The length and width of the top section 11 and the neck 12 of the device 10 are dimensioned accurately to ensure simple installation and removal of the cymbal 40. The length 11 of the top portion of the device is designed to prevent loss of the felt washer 50 during storage or transport of the assembly while the cymbal 40 is removed from the assembly. The length and width of the top feature 11 and the neck diameter 12 are co-designed to ensure proper retention of the cymbal 40 during use. The body diameter 14 of the device 10 is smaller than the diameter of the hole in the center of the cymbal 40 to ensure the cymbal 40 does not contact the device 10 during use. The shoulder of the device 13 is angled to assist in the cymbal 40 mounting and removal process. Included in the design are optional wrench flats 15 on opposite sides of the body 14 to assist in the assembly and disassembly process.

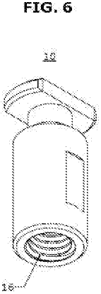

FIG. 6 illustrates a bottom perspective showing the thread features 16 of the cymbal mounting and retaining device 10 intended for mounting on a threaded tilter rod on a cymbal stand, boom arm or cymbal holder 70. The device 10 includes a centrally threaded bore 16 with internal threads adapted to engage and screwed onto the threaded portion 72 of the cymbal stand, boom arm or cymbal holder tilter rod 70.

1. The device eliminates the need for an upper felt washer and a conventional wing nut or similar retainer to secure the cymbal in place resulting in a reduction of components required to secure a cymbal onto the cymbal stand, boom arm, or cymbal holder.

2. The diameter of the device is smaller than the diameter of the mounting hole in a cymbal to avoid contact with the cymbal thereby preventing damage to the cymbal and allowing complete natural movement and vibration of the cymbal during use, which in turn results in the cymbal retaining and optimizing its intrinsic sound.

3. The device design eliminates the need to ensure that ancillary mounting components are mounted securely to prevent cymbals from failing off cymbal stands, boom arms, or cymbal holders during use, storage, or transport.

4. The device is designed to be permanently mounted on the cymbal stand or boom arm, enabling a user to install and remove a cymbal with a single hand, thereby simplifying assembly and disassembly of cymbal stands, boom arms, or cymbal holders during equipment set up and break down.

5. The device is threaded to securely mate to industry standard cymbal stands, boom arms and cymbal holders, and the thread length of the device is designed to accommodate various threaded rod lengths on the tilters of industry standard cymbal stands, boom arms, and cymbal holders.

6. The device material can be hard metal or plastic to enable subtractive or additive manufacturing processes.

7. The device may include optional indented wrench flat features to enable use of a conventional open-end wrench to assist in the installation process.

8. The top features of the device are dimensioned to enable easy mounting of conventional cymbals and prevent cymbals from falling off cymbal stands, boom arms or cymbal holders during use.

9. The device is designed to prevent cymbal sleeves and bottom felts from falling off when the cymbal is removed from a cymbal stand, boom arm, or cymbal holder, and when transporting said cymbal stands, boom arms, and cymbal holders.
